(19) United States
(12) Patent Application Publication
(10) Pub. No.: US 2016/0111809 A1
(43) Pub. Date: Apr. 21, 2016

(54) WATERPROOF CONNECTOR

(71) Applicant: YAZAKI CORPORATION, Tokyo (JP)

(72) Inventors: Masayuki KATAOKA, Kakegawa-shi, Shizuoka (JP); Fuminori SUGIYAMA, Kakegawa-shi, Shizuoka (JP); Hiroshi KAWAMURA, Makinohara-shi, Shizuoka (JP)

(73) Assignee: Yazaki Corporation, Tokyo (JP)

(21) Appl. No.: 14/896,445

(22) PCT Filed: Jul. 2, 2014
(86) PCT No.: PCT/JP2014/067684

§ 371 Date: Dec. 7, 2015

(30) Foreign Application Priority Data
Jul. 2, 2013 (JP) 2013-138793

(51) Int. Cl. H01R 13/52

(52) U.S. Cl. CPC H01R 13/5205

(57) ABSTRACT

Seal members (3) are formed in a film shape having one surface (13) and the other surface (14), and are molten films that are melted by heat when a connector housing (4) is molded. The seal members (3) include a first seal member (15) and a second seal member (16). The first seal member (15) is disposed in a plate section (12) of an intermediate section (9) of a terminal fitting (2). In addition, the second seal member (16) is disposed in an insulator (6) of an end of a high-voltage electric wire (1). The seal members (3) are formed by using nitrile rubber resin, phenol resin, and olefin-based resin.

### TECHNICAL FIELD

The present invention relates to a waterproof connector that is formed by embedding an electrical connection portion in a connector housing by mold forming.

### BACKGROUND ART

For example, electrical connection is provided between an inverter unit and a battery, and between the inverter unit and a motor unit, which are mounted on a hybrid vehicle or an electric vehicle, by a high-voltage wire harness. A connector having waterproofing properties, that is a waterproof connector is provided in an end of the wire harness.

A technique according to a configuration and a structure of the waterproof connector is disclosed in the following PTL 1. Hereinafter, the technique is described with reference to FIG. 9. A waterproof connector 101 is configured to include a metal terminal fitting 103 provided in an end of an electric wire 102, a resin connector housing 105 that is formed by embedding a portion to be mold-formed 104, and seal members 106 and 107 that prevent entering of water from an outside of the connector housing 105 to a connection portion between the electric wire 102 and the terminal fitting 103.

The portion to be mold-formed 104 described above corresponds to a range from an intermediate portion 108 of the terminal fitting 103 to a sheath cover section 109 of the end of the electric wire 102 and the portion to be mold-formed 104 is embedded in the connector housing 105.

The seal members 106 and 107 are made of silicone rubber or butyl rubber and materially has elasticity and adhesion properties. The seal members 106 and 107 are formed by allowing such a material to be a tape shape. The seal member 106 formed in the tape shape is wound around the intermediate portion 108 of the terminal fitting 103. Furthermore, the seal member 107 is wound around the sheath cover section 109 of the end of the electric wire 102. The seal members 106 and 107 are embedded together with the portion to be mold-formed 104 along with molding of the connector housing 105.

### CITATION LIST

### Patent Literature

[PTL 1] JP-A-2009-252712

### SUMMARY OF INVENTION

### Technical Problem

In the waterproof connector 101 of the related art described above, since the seal members 106 and 107 having elasticity and the like are used, there is a problem that the seal members 106 and 107 are likely to be deformed by heat of a resin material and then molding defects are caused when the connector housing 105 is molded. Furthermore, there is a concern that an uneven thickness occurs in the seal members 106 and 107, in other words, the thicknesses of the seal members 106 and 107 are not constant, and the like when the connector housing 105 is molded. Thus, there is also a problem that the expected waterproofing properties are not obtained.

The present invention is made in view of the situations described above and an object of the present invention is to provide a waterproof connector capable of ensuring stable waterproofing properties and moldability.

### Solution to Problem

The present invention that is made to solve the problems described above provides a waterproof connector including: a metal terminal fitting that has an electrical contact section, an electric wire connection section, and an intermediate section positioned between the electrical contact section and the electric wire connection section, and is provided in an electric wire end through the electric wire connection section; a resin connector housing in which a portion to be mold-formed including the intermediate section and a sheath cover section of the electric wire end is embedded; and a seal member that is disposed in the portion to be mold-formed and prevents entering of water from an outside of the connector housing to the electric wire connection section, in which the seal member is a resin molten film that is melted by heat when the connector housing is molded.

The waterproof connector according to the present invention having such a feature employs the molten film as the seal member. Since the molten film is melted by heat when the connector housing is molded and comes into close contact with the portion to be mold-formed including the intermediate section of the terminal fitting and the sheath cover section of the electric wire end, entering of water from the outside of the connector housing is prevented. Specifically, even if slight irregularities exist, since the molten film solidly comes into close contact with the portion to be mold-formed in a state where the molten film, that is, molten resin, enters the slight irregularities, formation of an entering path of water is prevented and thereby waterproofing properties are ensured. Furthermore, according to the present invention, even if the seal member does not have elasticity, it is possible to ensure the waterproofing properties. Thus, the seal member is not deformed by pressure and the like when the connector housing is molded and, as a result, molding defects are prevented. Even if the molten film is melted by the heat when the connector housing is molded, waterproofing properties are ensured by allowing the molten film itself to remain. Thus, conditions for non-defective products according to product inspection can be taken widely. In addition, it is preferable that a material of the molten film has adhesion properties to the terminal fitting or the sheath cover section of the electric wire end better than the resin material of the connector housing. Furthermore, it is preferable that the material has adhesion properties that are better than mere rubber material.

Furthermore, in the waterproof connector of the present invention described above, the seal members include a first seal member disposed in the intermediate section and a second seal member disposed in the sheath cover section.

According to the present invention having such a feature, it is the waterproof connector employing the first seal member and the second seal member as the seal members . If the first seal member and the second seal member are disposed in the front and rear of the electrical connection portion, entering of water from the outside of the connector housing to the electrical connection portion is reliably prevented.

Furthermore, in the waterproof connector according to the present invention, the seal member is formed in a cylindrical shape covering a portion from the intermediate section to the sheath cover section.

According to the present invention having such a feature, it is the waterproof connector that is formed by employing the cylindrical shape as the seal members. If the seal member is disposed so as to cover from the intermediate section of the terminal fitting to the sheath cover section of the electric wire end, entering of water from the outside of the connector housing to the electrical connection portion is reliably prevented.

### Advantageous Effects of Invention

According to the present invention, since the molten film is employed as the seal member, an effect that stable waterproofing properties and moldability can be ensured compared to the related art is achieved.

Furthermore, according to the present invention, since the seal member formed of the first seal member and the second seal member is employed and is disposed in the front and rear of the electrical connection portion, an effect that waterproofing can be reliably provided is achieved.

Furthermore, according to the present invention, since the cylindrical seal members are employed and cover the front and rear of the electrical connection portion, an effect that waterproofing can be reliably provided is achieved.

### BRIEF DESCRIPTION OF DRAWINGS

FIG. 1 is a sectional view of a main portion of a waterproof connector of an example 1 of the present invention.

FIG. 2 is a perspective view of a terminal fitting and an electric wire end.

FIG. 3 is a perspective view illustrating when a first seal member and a second seal member are provided from a state of FIG. 2.

FIG. 4 is a perspective view illustrating when a connector housing is molded in a state of FIG. 3.

FIG. 5 is a perspective view illustrating when formation of the waterproof connector is completed by providing a shield shell and the like in a state of FIG. 4.

FIG. 6 is a sectional view of a main portion of a waterproof connector of an example 2 of the present invention.

FIG. 7 is a perspective view illustrating when seal members are provided through the terminal fitting and the electric wire end.

FIG. 8 is an explanatory view related to holding of the seal members.

FIG. 9 is a sectional view of a waterproof connector of the related art.

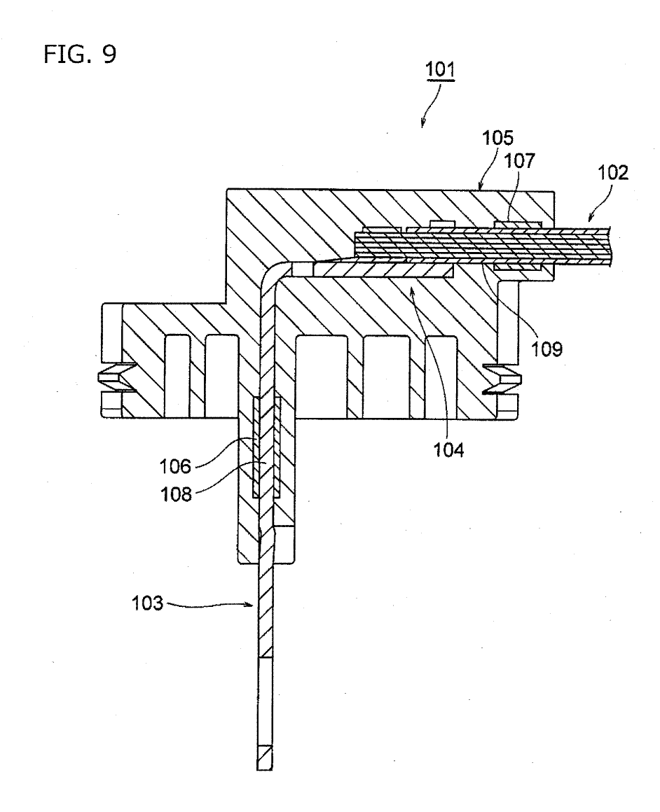

### DESCRIPTION OF EMBODIMENTS

A waterproof connector is configured to include a metal terminal fitting, a resin connector housing, and a seal member disposed in a portion to be mold-formed. The seal member is a resin molten film that is melted by heat when the connector housing is molded.

### Example 1

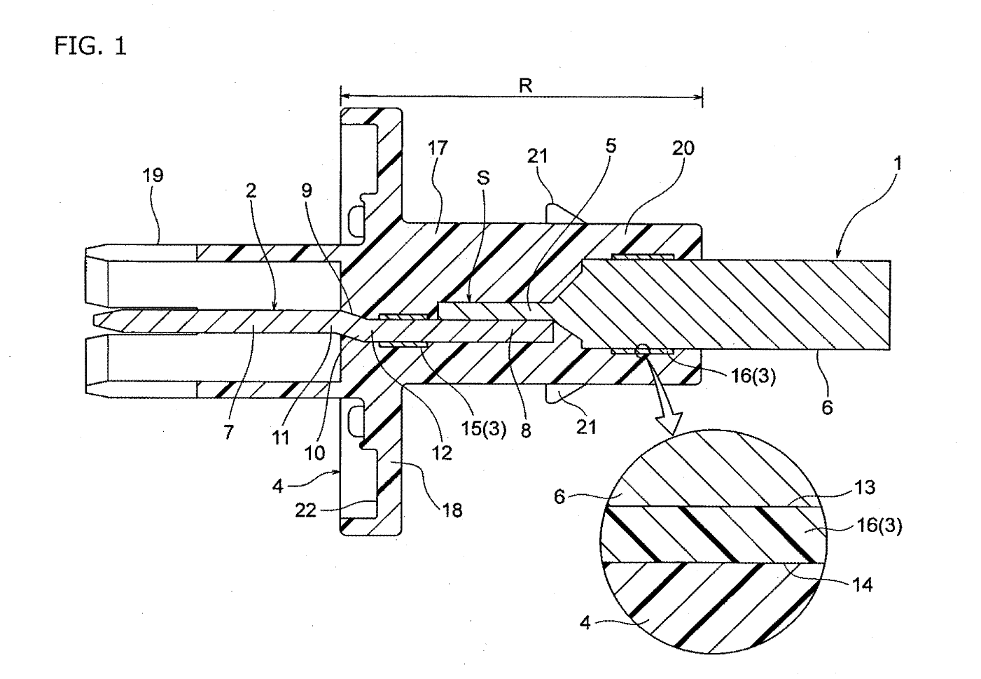

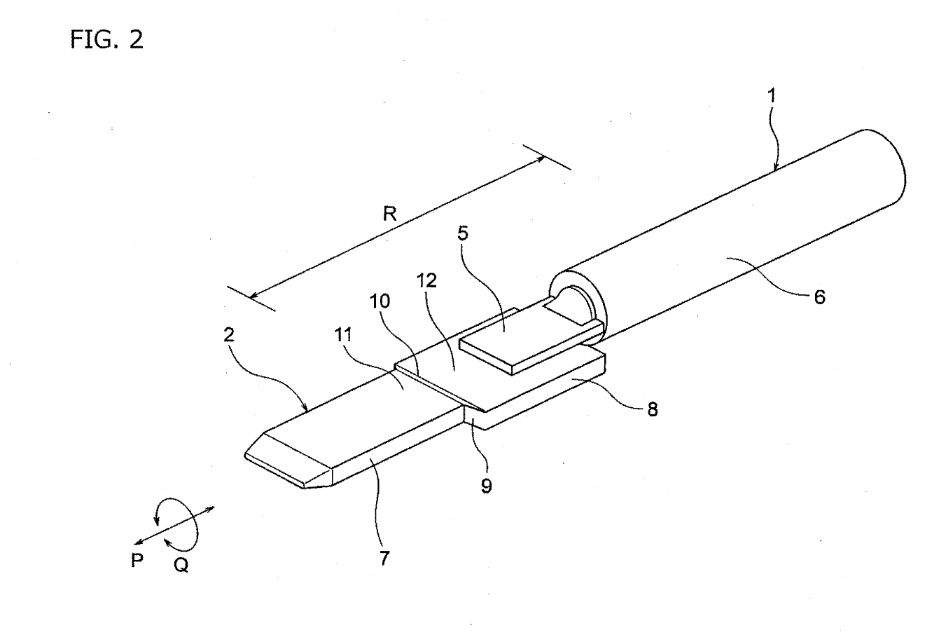

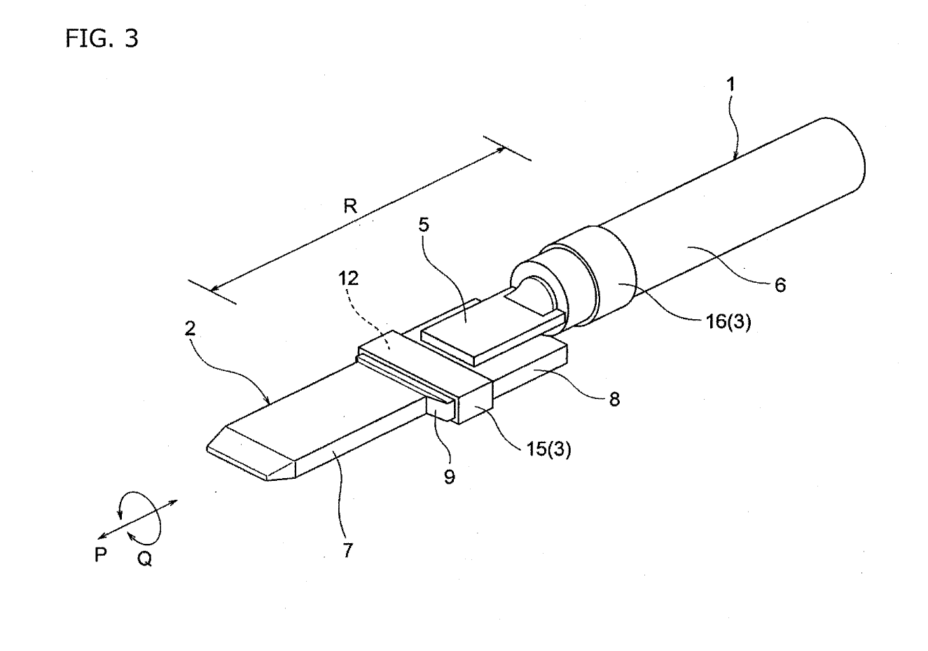

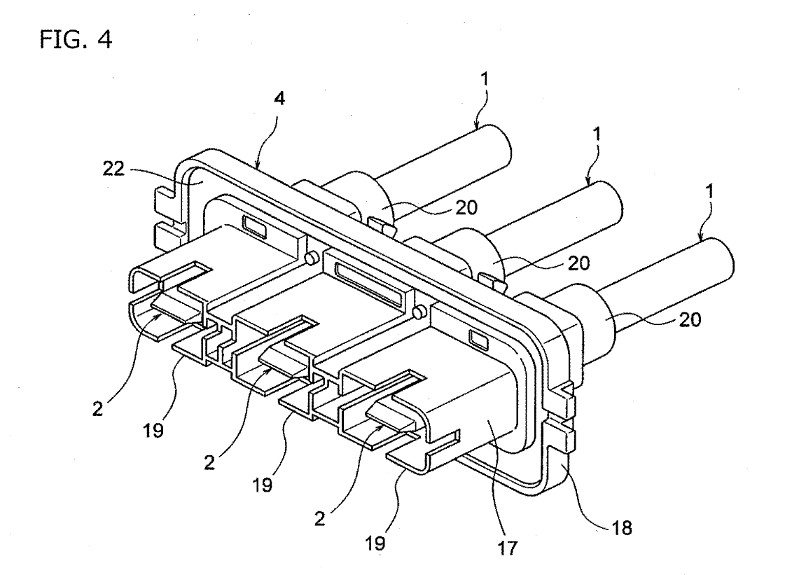

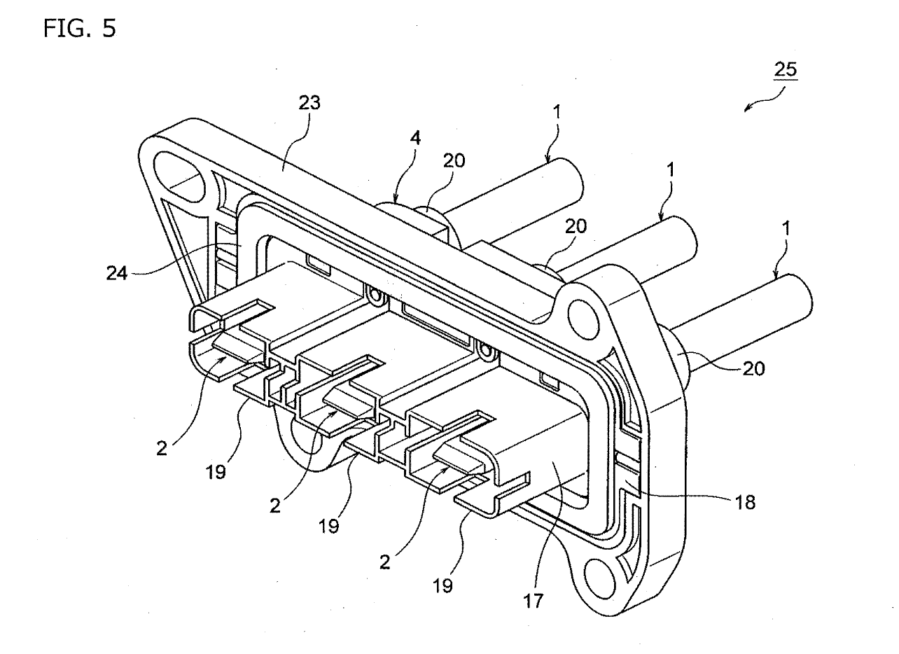

Hereinafter, an example 1 will be described with reference to the drawings. FIG. 1 is a sectional view of a main portion of a waterproof connector. Furthermore, FIG. 2 is a perspective view of a terminal fitting and a electric wire end, FIG. 3 is a perspective view illustrating when a first seal member and a second seal member are provided from a state of FIG. 2, FIG. 4 is a perspective view illustrating when a connector housing is molded from a state of FIG. 3, and FIG. 5 is a perspective view illustrating when formation of a waterproof connector is completed by providing a shield shell and the like from a state of FIG. 4.

Here, a part of a shielded connector is illustrated in FIG. 1 (see FIG. 5 for an external shape of the shielded connector). In addition, the shielded connector is an example of the waterproof connector of the present invention. Reference numeral 1 indicates a high-voltage electric wire (electric wire), reference numeral 2 indicates a terminal fitting, reference numeral 3 indicates a seal member, reference numeral 4 indicates a connector housing. First, a detailed structure of each configuration described above will be described.

The high-voltage electric wire 1 is a high-voltage conductive path for electrically connecting an inverter unit and a motor unit mounted on, for example, a vehicle (not illustrated), and three high-voltage electric wires 1 are provided if the two units described above are connected. The high-voltage electric wire 1 is configured to include a conductor 5 and an insulator 6 (sheath cover section) that covers the conductor 5. The high-voltage electric wire 1 is formed in a circular cross section. An end of the high-voltage electric wire 1 is processed such that the insulator 6 is removed by a predetermined length and the conductor 5 is exposed. The conductor 5 is made of aluminum, aluminum alloy, copper, copper alloy, and the like, and here, a conductor structure (conductor structure is an example) formed of twisted electric wires is employed.

The insulator 6 is formed by extruding a resin material having insulating properties on the outside of the conductor 5. As the resin material, polyethylene-based resin, polypropylene-based resin, polyvinyl chloride resin, and the like are exemplified. The insulator 6 is formed of a general resin material.

In FIGS. 1 and 2, the terminal fitting 2 is formed by press forming a metal plate of copper or copper alloy. Here, the terminal fitting 2 is formed in a substantially strip shape of which an intermediate portion is stepped. The terminal fitting 2 having such a shape has an electrical contact section 7 that is connected to a counterpart terminal (not illustrated), an electric wire connection section 8 to which the conductor 5 of an end of the high-voltage electric wire 1 is connected, and an intermediate section 9 that is positioned between the electrical contact section 7 and the electric wire connection section 8.

The electrical contact section 7 is formed in a tab-shape as illustrated in the drawings. In addition, in the example, the electrical contact section 7 is a male type, but for example, the electrical contact section 7 is formed in a box shape if the electrical contact section 7 is a female type. The electrical contact section 7 is disposed within a connector fitting section 19 in a housing body section 17 of the connector housing 4 described below.

The intermediate section 9 is formed so as to connect the electrical contact section 7 and the electric wire connection section 8 in an intermediate portion of the terminal fitting 2. The intermediate section 9 is formed in a substantially crank shape having a stepped section 10, a plate section 11 that is disposed on the electrical contact section 7 side, and a plate section 12 that is disposed on the electric wire connection section 8 side in which the stepped section 10 is interposed therebetween.

Front and rear surfaces of the plate section 12 on the electric wire connection section 8 side are formed as flat surfaces. In addition, both side surfaces are also formed as surfaces having a typical machining roughness. That is, the plate section 12 is formed in the same state as the electrical contact section 7 or the plate section 11 on the electrical contact section 7 side without performing special processing. A first seal member 15 described below is disposed in the plate section 12. In addition, the following description is given in which an arrow P is defined as an axial direction of the terminal fitting 2 and an arrow Q is defined as a circumferential direction of the terminal fitting 2 or the plate section 12 in FIG. 2.

The electric wire connection section 8 is formed in a plate shape. Specifically, the electric wire connection section 8 is formed in a shape formed by directly stretching the plate section 12 on rear side in the axial direction. The electric wire connection section 8 is electrically connected to the conductor 5 of the end of the high-voltage electric wire 1. In the example, the electric wire connection section 8 is connected to the conductor 5 by welding in a state where the conductor 5 is crushed. In addition, the connection by welding is an example and other connection methods may be employed. That is, for example, the connection maybe provided by forming a well-known wire barrel and crimping the electric wire connection section 8 and the conductor 5 using the wire barrel.

In FIGS. 1 and 3, the seal members 3 are provided as members for preventing entering of water from an outside of the connector housing 4 to the electrical connection portion. Specifically, the seal members 3 are provided as members for preventing entering of water to a connection portion between the electric wire connection section 8 of the terminal fitting 2 and the conductor 5 of the high-voltage electric wire 1. The seal members 3 are disposed at positions described below in a predetermined range R including the intermediate section 9 of the terminal fitting 2 and the insulator 6 of the end of the high-voltage electric wire 1.

In addition, a part of the terminal fitting 2 and a part of the high-voltage electric wire 1 included in the predetermined range R correspond to a portion to be mold-formed S.

The seal member 3 is formed in a film shape having one surface 13 and the other surface 14, and is a molten film that is melted when the connector housing 4 is molded. The first seal member 15 and a second seal member 16 are provided as the seal members 3. The first seal member 15 is disposed in the plate section 12 of the intermediate section 9 of the terminal fitting 2. In addition, the second seal member 16 is disposed in the insulator 6 of the end of the high-voltage electric wire 1. The first seal member 15 and the second seal member 16 are respectively formed in a strip shape. A reason for forming the first seal member 15 and the second seal member 16 in the strip shape is that wiring is facilitated when winding the first seal member 15 and the second seal member 16 at the disposition positions described above in the circumferential direction (arrow Q). In addition, the shape is not limited to the strip shape and may be a circular shape.

The seal member 3 that is the molten film is formed from a material that is softened and melted by heat (heat of molten resin) when the connector housing 4 is molded and. In addition, the seal member 3 is formed from a material that satisfies a heatresistant temperature of the connector. As a specific example, the seal member 3 is formed by using nitrile rubber resin, phenol resin, and olefin-based resin. Furthermore, as the seal member 3, of course, the molten film alone is employed and a thin base material with the molten film provided on both surfaces thereof may be employed. The seal member 3 does not have elasticity which allows deformation to occur when the connector housing 4 is molded.

The one surface 13 of the seal member 3 (first seal member 15 and the second seal member 16) comes into close contact with the plate section 12 of the intermediate section 9 of the terminal fitting 2 or the insulator 6 of the end of the high-voltage electric wire 1 if the seal member 3 is melted by heat when the connector housing 4 is molded. In this case, if there are slight irregularities, the one surface 13 solidly comes into close contact with the plate section 12 or the insulator 6 so as to embed the irregularities. Furthermore, similarly, the other surface 14 comes into close contact with the connector housing 4.

The seal member 3 (first seal member 15 and the second seal member 16) is formed to have a length such that one end of the seal member 3 is, at least overlapped on the other end thereof when being wound. In addition, width dimensions of the first seal member 15 and the second seal member 16 are set to be appropriate lengths in consideration of a space of the plate section 12 of the intermediate section 9 and the like.

Referring back to FIG. 1, the connector housing 4 is a resin molded product having insulating properties and has a housing body section 17 and a flange section 18 connected to an intermediate portion of the housing body section 17.

The connector fitting section 19 where the electrical contact section 7 of the terminal fitting 2 is disposed on the inside thereof and a mold section 20 in which the portion to be mold-formed S is embedded are integrally formed in the housing body section 17. The connector fitting section 19 is a fitting portion connected to a counterpart connector and is formed in a box shape. The mold section 20 is formed as a solid portion having a predetermined external shape. Engagement protrusions 21 are formed on an outer surface of the mold section 20 as engagement portions with respect to a shield shell 23 described later (see FIG. 5).

The flange section 18 is formed in a collar shape protruding outwardly from the intermediate portion of the housing body section 17. In the example, the flange section 18 is formed as a portion abutting a shield case of the inverter unit or the motor unit. A packing receiving groove 22 is formed in the flange section 18. The packing receiving groove 22 is formed in a groove shape to be circular.

Next, an assembling step (operation) of the shielded connector will be described with reference to the configuration and the structure described above.

In FIG. 2, in a first step, an operation of connecting the conductor 5 of the end of the high-voltage electric wire 1 and the electric wire connection section 8 of the terminal fitting 2 is performed. As a connection method, an appropriate method such as welding, depositing, and soldering is employed. In the example, the connection is performed by welding.

In FIG. 3, in a second step, an operation of disposing the first seal member 15 in the plate section 12 of the intermediate section 9 of the terminal fitting 2 and an operation of disposing the second seal member 16 in the insulator 6 of the end of the high-voltage electric wire 1 are performed. The first seal member 15 and the second seal member 16 are disposed in the predetermined range R including the intermediate section 9 of the terminal fitting 2 and the insulator 6 of the end of the high-voltage electric wire 1. The first seal member 15 and the second seal member 16 are disposed by being wound. The first seal member 15 and the second seal member 16 are wound without a gap.

In FIG. 4, in a third step, an operation of resin-molding the connector housing 4 is performed. The resin molding is performed in a state where the terminal fitting 2 in which the first seal member 15 and the second seal member 16 are disposed are set in the mold of the connector housing 4. The connector housing 4 is resin-molded so that the portion to be mold-formed S is embedded (see FIG. 1) . The first seal member 15 and the second seal member 16 are melted by heat of the resin molding and the one surface 13 comes into close contact with the plate section 12 of the intermediate section 9 of the terminal fitting 2 or the insulator 6 of the end of the high-voltage electric wire 1. In addition, similarly, the other surface 14 also comes into close contact with the connector housing 4. After the resin molding, the connector housing 4 is taken out from the mold. The terminal fitting 2 is water-tightly fixed in accordance with the resin molding of the connector housing 4.

In FIG. 5, in a fourth step, an assembling operation of the metal shield shell 23, a rubber unit packing 24, and the like with respect to the connector housing 4 is performed. Furthermore, a fixing operation of a shield member (for example, cylindrical braid, metal foil, and the like) (not illustrated) for collectively covering three high-voltage electric wires 1 that are cylindrically formed is performed with respect to the shield shell 23. In addition, fixing of the shield member is performed by using a metal shield ring (not illustrated). When sequentially going through the fourth step, assembly of a shielded connector 25 having waterproofing properties is completed.

Above, as described with reference to FIGS. 1 to 5, according to the shielded connector 25, the seal member 3 is included to ensure waterproofing properties. The seal member 3 employs the molten film that is melted by the heat when the connector housing 4 is molded and the first seal member 15 and the second seal member 16 are provided as the seal member 3. The one surface 13 and the other surface 14 of the seal member 3 are melted and thereby since the close contact state is reliably formed, entering of water from the outside of the connector housing 4 is prevented. Specifically, even if slight irregularities exist, since the molten film enters the slight irregularities, and since the entered film solidly comes into close contact with the slight irregularities, formation of the entering path of water is prevented and thereby waterproofing properties are ensured.

Furthermore, according to the shielded connector 25, since the molten film is employed as the seal member 3, deformation due to pressure and the like of resin molding of the connector housing 4 does not occur, and as a result, molding defects can be prevented.

Thus, according to the present invention, since the molten film is employed as the seal member 3, an effect that stable waterproofing properties and moldability can be ensured is achieved compared to an example of the related art. Furthermore, since the first seal member 15 and the second seal member 16 are disposed in the front and the rear of the electrical connection portion, an effect that waterproofing can be reliably provided is also achieved.

### Example 2

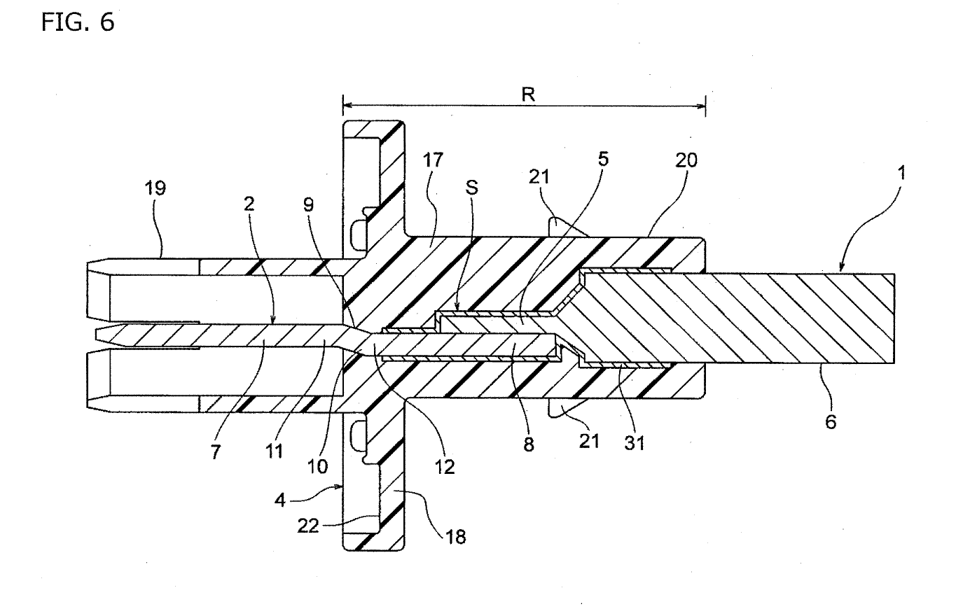

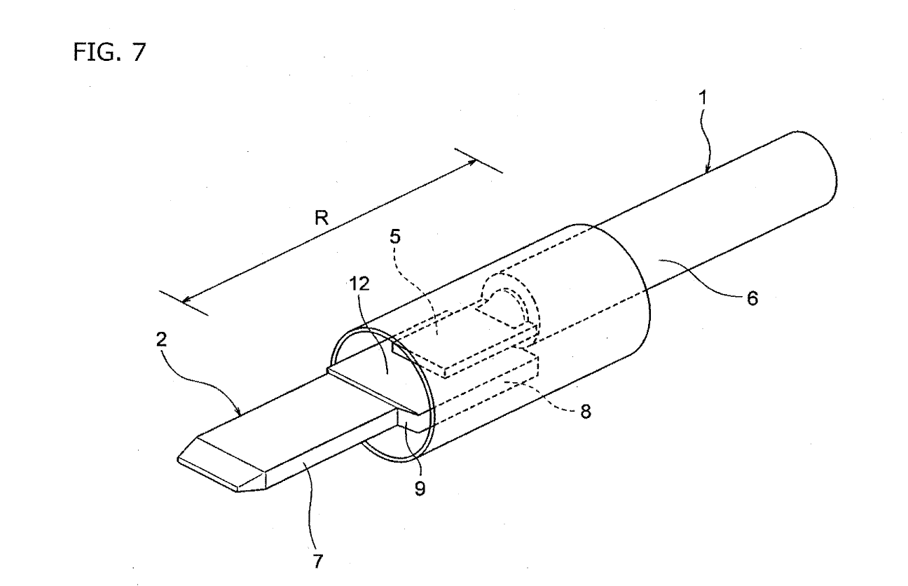

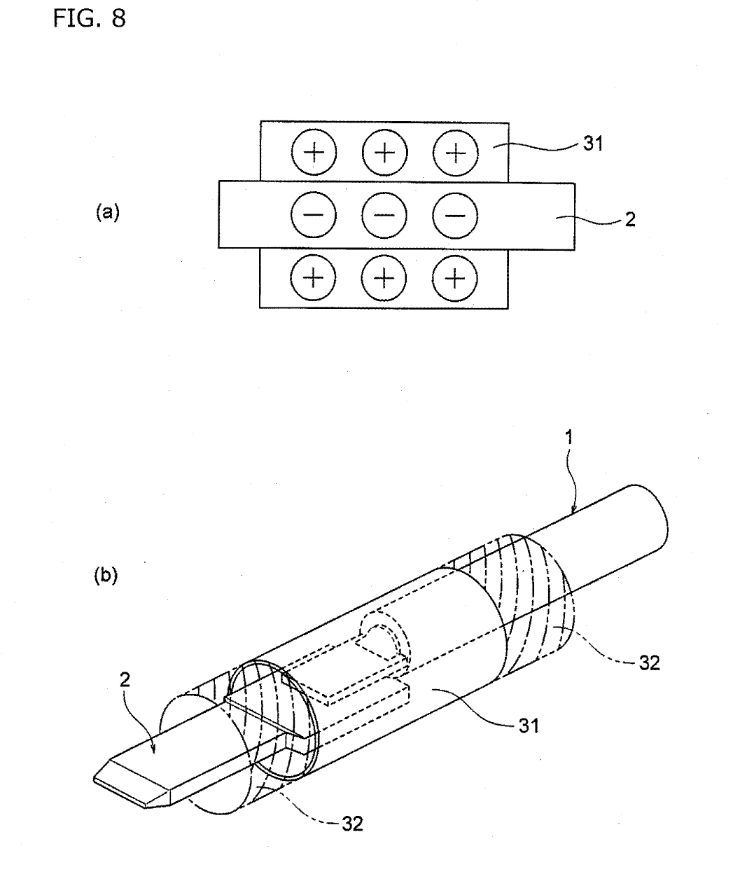

Hereinafter, an example 2 will be described with reference to the drawings. FIG. 6 is a sectional view of a main portion of a waterproof connector of the present invention. Furthermore, FIG. 7 is a perspective view illustrating when seal members are provided through a terminal fitting and an electric wire end and FIG. 8 is an explanatory view related to holding of the seal members. In addition, the same reference numerals are given to the basically same configuration members in the example 1 and detailed description will be omitted.

In FIG. 6, reference numeral 1 indicates a high-voltage electric wire (electric wire), reference numeral 2 indicates a terminal fitting, reference numeral 31 indicates a seal member, and reference numeral 4 indicates a connector housing. The example 2 employs the seal member 31 instead of the seal members 3 of the example 1.

In FIGS. 6 and 7, the seal member 31 is included as a member for preventing entering of water from the outside of the connector housing 4 to an electrical connection portion. Specifically, the seal member 31 is included as a member for preventing entering of water to a connection portion between an electric wire connection section 8 of the terminal fitting 2 and a conductor 5 of the high-voltage electric wire 1. The seal member 31 is the same molten film as that of the example 1 and is formed by rolling the molten film in a cylindrical shape. The seal member 31 is formed so as to cover from an intermediate section 9 of the terminal fitting 2 to an insulator 6 of the end of the high-voltage electric wire 1. The seal member 31 is disposed so as to occupy majority in a predetermined range R.

If the seal member 31 is melted by heat when the connector housing 4 is molded, the seal member 31 comes into close contact with a wide range from the intermediate section 9 of the terminal fitting 2 to the insulator 6 of the end of the high-voltage electric wire 1 (see FIG. 6). In this case, if slight irregularities exist, the seal member 31 solidly comes into close contact with the wide range so as to embed the irregularities. In addition, the seal member 31 also comes into close contact with the connector housing 4.

In the configuration and the structure described above, in a first step in an assembling step (operation), an operation of connecting the conductor 5 of the end of the high-voltage electric wire 1 and the electric wire connection section 8 of the terminal fitting 2 is performed. As a connection method, an appropriate method such as welding, depositing, and soldering is employed. In the example, the connection is performed by welding.

In a second step, an operation of covering a portion from the intermediate section 9 of the terminal fitting 2 to the insulator 6 of the end of the high-voltage electric wire 1 by the cylindrical seal member 31. The seal member 31 is disposed within the predetermined range R.

In a third step, an operation of resin molding the connector housing 4 is performed. The resin molding is performed in a state where the terminal fitting 2 in which the seal member 31 is disposed is set in a mold of the connector housing 4. The connector housing 4 is resin molded so that a portion to be mold-formed S is embedded. The seal member 31 is melted by heat of resin molding and the seal member 31 comes into close contact with a plate section 12 of the intermediate section 9 of the terminal fitting 2 or the insulator 6 of the end of the high-voltage electric wire 1. In addition, similarly, the seal member 31 comes into close contact with the connector housing 4. After resin molding, the connector housing 4 is taken out from the mold. The terminal fitting 2 is water-tightly fixed in accordance with the resin molding of the connector housing 4.

Furthermore, a fourth step is performed similarly to the example 1. When sequentially going through the fourth step, assembly of a shielded connector having waterproofing properties is completed.

Here, when describing holding of the seal member 31 during resin molding, an example in which the seal member 31 is held by static electricity is included. That is, as illustrated in FIG. 8(a), if the terminal fitting 2 is charged in negative and the seal member 31 is charged in positive, the seal member 31 is electrically attracted, the seal member 31 sticks to the terminal fitting 2, and thereby the seal member 31 is held. Thus, a position of the seal member 31 is stable during resin molding.

In addition, as illustrated in FIG. 8(b), it is also effective to form a mold pressing section 32 in one end and/or the other end of the seal member 31, and to hold the mold pressing section 32 by pressing in a mold.

Above, as described with reference to FIGS. 6 to 8, of course, the example 2 achieves the same effects as those of the example 1. That is, since the molten film is employed as the seal member 31, an effect that stable waterproofing properties and moldability can be ensured is achieved compared to an example of the related art. Furthermore, since the cylindrical seal member 31 is employed and covers a portion including the front and rear of the electrical connection portion, an effect that waterproofing can be reliably provided is achieved.

In addition, of course, the present invention can be variously modified within a scope which does not change the gist of the present invention.

Here, features of the embodiments of the waterproof connector according to the present invention described above are briefly summarized and listed in the following [1] to [3].

[1] A waterproof connector includes

a metal terminal fitting (2) that has an electrical contact section (7), an electric wire connection section (8), and an intermediate section (9) positioned between the electrical contact section and the electric wire connection section, and is provided in the electric wire end through the electric wire connection section,

a resin connector housing (4) in which a portion to be mold-formed (S) including the intermediate section and a sheath cover section (insulator 6) of an electric wire end is embedded, and

a seal member (3) that is disposed in the portion to be mold-formed and prevents entering of water from an outside of the connector housing to the electric wire connection section,

wherein the seal member is a resin molten film that is melted by heat when the connector housing is molded.

[2] The waterproof connector according to [1],

in which the seal member includes a first seal member (15) disposed in the intermediate section and a second seal member (16) disposed in the sheath cover section.

[3] The waterproof connector according to [1],

wherein the seal member is formed in the cylindrical shape covering a portion from the intermediate section to the sheath cover section.

The present invention is described with reference to the detailed or specific embodiment, and is apparent to those skilled in the related art that it is possible to make various changes and modifications without departing from the scope of the present invention.

This application is based on Japanese patent application filed on Jul. 2, 2013 (Japanese Patent Application No. 2013-138793) the contents of which are incorporated herein by reference.

### INDUSTRIAL APPLICABILITY

According to the present invention, since the molten film is employed as the seal member, an effect that stable waterproofing properties and moldability can be ensured are achieved compared to the related art. The present invention achieving the effects is useful for the waterproof connector formed by embedding the electrical connection portion in the connector housing by mold forming.

### Reference Signs List

R . . . predetermined range
S . . . portion to be mold-formed
1 . . . high-voltage electric wire (electric wire)
2 . . . terminal fitting
3 . . . seal member
4 . . . connector housing
5 . . . conductor
6 . . . insulator (sheath cover section)
7 . . . electrical contact section
8 . . . electric wire connection section
9 . . . intermediate section
10 . . . stepped section
11, 12 . . . plate section
13 . . . one surface
14 . . . other surface
15 . . . first seal member
16 . . . second seal member
17 . . . housing body section
18 . . . flange section
19 . . . connector fitting section
20 . . . mold section
21 . . . engagement protrusion
22 . . . packing receiving groove
23 . . . shield shell
24 . . . unit packing
25 . . . shielded connector (waterproof connector)
31 . . . seal member
32 . . . mold pressing section

1. A waterproof connector comprising:
a metal terminal fitting that has an electrical contact section, an electric wire connection section, and an intermediate section positioned between the electrical contact section and the electric wire connection section, and is provided in an electric wire end through the electric wire connection section;
a resin connector housing in which a portion to be mold-formed including the intermediate section and a sheath cover section of the electric wire end is embedded; and
a seal member that is disposed in the portion to be mold-formed and prevents entering of water from an outside of the connector housing to the electric wire connection section,
wherein the seal member is a resin molten film that is melted by heat when the connector housing is molded.

2. The waterproof connector according to claim 1,
wherein the seal member comprises a first seal member disposed in the intermediate section and a second seal member disposed in the sheath cover section.

3. The waterproof connector according to claim 1,
wherein the seal member is formed in a cylindrical shape covering a portion from the intermediate section to the sheath cover section.
